(19) United States
(12) Patent Application Publication
(10) Pub. No.: US 2026/0349374 A1
(43) Pub. Date: Nov. 5, 2026

(54) CLEANING DEVICE, INTERMEDIATE TRANSFER BELT UNIT, AND IMAGE FORMING APPARATUS

(71) Applicants: Yuuji MEGURO, Kanagawa (JP); Yoshiki HOZUMI, Kanagawa (JP); Masaharu FURUYA, Kanagawa (JP); Naohiro KUMAGAI, Kanagawa (JP)

(72) Inventors: Yuuji MEGURO, Kanagawa (JP); Yoshiki HOZUMI, Kanagawa (JP); Masaharu FURUYA, Kanagawa (JP); Naohiro KUMAGAI, Kanagawa (JP)

(21) Appl. No.: 19/650,403

(22) Filed: Apr. 17, 2026

(30) Foreign Application Priority Data
May 1, 2025 (JP) 2025-075899

(51) Int. Cl. G03G 15/16; G03G 15/01; G03G 21/00; G03G 21/10; G03G 21/12

(52) U.S. Cl. CPC G03G 15/161; G03G 21/0011; G03G 21/105; G03G 21/12; G03G 15/0131; G03G 15/0189

(57) ABSTRACT

A cleaning device includes a cleaner, a first flexible sheet, and a second flexible sheet. The cleaner contacts, at a first position, a surface of an image bearer moving in a moving direction to remove substances adhering to the surface of the image bearer. The first flexible sheet contacts the image bearer at a second position upstream of the first position in the moving direction. The second flexible sheet contacts the image bearer at a third position upstream of the second position in the moving direction.

### CROSS-REFERENCE TO RELATED APPLICATION

This patent application is based on and claims priority pursuant to 35 U.S.C. § 119(a) to Japanese Patent Application No. 2025-075899, filed on May 1, 2025, in the Japan Patent Office, the entire disclosure of which is hereby incorporated by reference herein.

### BACKGROUND

### Technical Field

The present disclosure relates to a cleaning device that removes toner adhering to the surface of an image bearer, an intermediate transfer belt unit including the cleaning device, and an image forming apparatus, such as a copier, a printer, a facsimile machine, or a multifunction peripheral having the functions thereof.

### Related Art

In the related art, an image forming apparatus, such as a copier or a printer, includes a cleaning device that removes substances, such as toner, adhering to the surface of an image bearer, such as an intermediate transfer belt, a photoconductor drum, or a photoconductor belt.

Specifically, the cleaning device includes a cleaning blade (cleaner) that contacts the image bearer at a predetermined contact angle and a predetermined contact force. The cleaning blade scrapes off toner adhering to the surface of the image bearer and collects the scraped toner into the cleaning device.

Such a cleaning device includes a flexible sheet (inlet seal) that contacts the image bearer on the most upstream side to prevent the substances, such as the toner collected in the cleaning device, from scattering outward from the cleaning device.

### SUMMARY

The present disclosure described herein provides an improved cleaning device including a cleaner, a first flexible sheet, and a second flexible sheet. The cleaner contacts, at a first position, a surface of an image bearer moving in a moving direction to remove substances adhering to the surface of the image bearer. The first flexible sheet contacts the image bearer at a second position upstream of the first position in the moving direction. The second flexible sheet contacts the image bearer at a third position upstream of the second position in the moving direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming apparatus;

FIG. 2 is a diagram illustrating a configuration of an image forming unit;

FIG. 3 is a diagram illustrating a configuration of a cleaning device;

FIG. 4 is a schematic perspective view of an image forming apparatus with a body door opened;

FIG. 5 is a schematic perspective view of a cleaning device removed from an intermediate transfer belt unit;

FIG. 6 is a diagram illustrating a cleaning device according to a comparative example; and

FIG. 7 is a diagram illustrating a cleaning device according to a modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In a cleaning device including a flexible sheet according to a comparative example, the flexible sheet may be undulate, and thus substances collected in the cleaning device may leak outward from the cleaning device through the undulated portion of the flexible sheet.

The present disclosure has been made in order to solve the above-described situation, and an object of the present disclosure is to provide a cleaning device, an intermediate transfer belt unit, and an image forming apparatus that prevent the substances collected in the cleaning device from leaking outward from the cleaning device.

Embodiments of the present disclosure are described below in detail with reference to the drawings. In the drawings, like reference signs denote like elements, and overlapping descriptions may be simplified or omitted as appropriate.

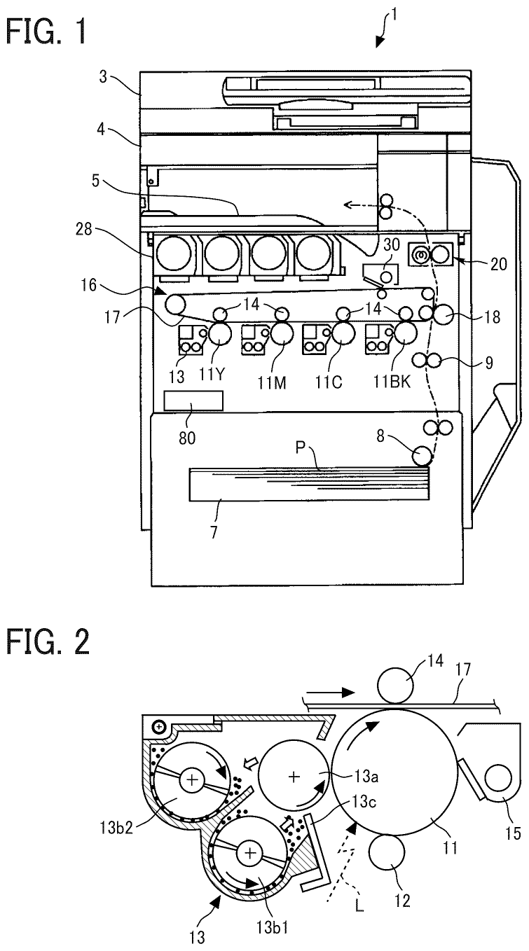

The overall configuration and operation of an image forming apparatus 1 will be described with reference to FIG. 1.

In FIG. 1, the image forming apparatus 1 as a tandem color copier includes a document conveyor 3 that conveys a document to a document reader 4, the document reader 4 that reads image information on the document, a sheet ejection tray 5 for stacking an output image, a sheet feeder 7 that stores sheets P, such as sheets of paper, and a registration roller pair (timing roller pair) 9 that adjusts the conveying timing of a sheet P.

The image forming apparatus 1 further includes photoconductor drums 11Y, 11M, 11C, and 11BK for forming yellow, magenta, cyan, and black toner images, respectively, developing devices 13 that develop the respective electrostatic latent images formed on the photoconductor drums 11Y, 11M, 11C, and 11BK, and primary transfer rollers 14 that transfer and superimpose the respective toner images formed on the photoconductor drums 11Y, 11M, 11C, and 11BK onto an image bearer.

The image forming apparatus 1 further includes an intermediate transfer belt unit 16, an intermediate transfer belt 17 as an image bearer onto which toner images of multiple colors are transferred and superimposed, a secondary transfer roller 18 that transfers a color image on the intermediate transfer belt 17 onto a sheet P, and a fixing device 20 that fixes an unfixed image on the sheet P.

The image forming apparatus 1 further includes toner containers 28 that store yellow, cyan, magenta, and black toners to be supplied to the developing devices 13, a cleaning device 30 that removes substances such as toner adhering to the surface of the intermediate transfer belt 17 (untransferred toner) to clean the surface of the intermediate transfer belt 17 (i.e., the image bearer), and a waste-toner container 80 that collects the untransferred toner removed by the cleaning device 30 as waste toner.

The operation of the image forming apparatus to form a typical color image will be described below. An image forming process on the photoconductor drums 11Y, 11M, 11C, and 11BK is also described with reference to FIG. 2.

First, a document is conveyed from a document table by conveyance rollers of the document conveyor 3 and then is placed on an exposure glass of the document reader 4. The document reader 4 optically reads image information on the document placed on the exposure glass.

Then, yellow image information, magenta image information, cyan image information, and black image information are transmitted to a writing device. The writing device emits respective laser beams L (refer to FIG. 2) based on the yellow image information, the magenta image information, the cyan image information, and the black image information to the surfaces of the corresponding photoconductor drums 11Y, 11M, 11C, and 11BK.

Meanwhile, the four photoconductor drums 11Y, 11M, 11C, and 11BK each rotate (travel) clockwise in FIG. 1. Chargers 12 (see FIG. 2) disposed opposite the photoconductor drums 11Y, 11M, 11C, and 11BK uniformly charge the surfaces of the photoconductor drums 11Y, 11M, 11C, and 11BK, respectively (charging process). Thus, the surface of each of the photoconductor drums 11Y, 11M, 11C, and 11BK has a charged potential. Subsequently, the charged surface of each of the photoconductor drums 11Y, 11M, 11C, and 11BK reaches a position to receive the laser beam L.

Four light sources of the writing device each emit the laser beam L in response to an image signal corresponding to each color. The respective laser beams for yellow, magenta, cyan, and black components pass through different optical paths (exposure process).

The laser beam L corresponding to the yellow component is emitted to the surface of the photoconductor drum 11Y, which is the first photoconductor drum from the left in FIG. 1. A polygon mirror that rotates at high velocity deflects the laser beam L for the yellow component along the axis of rotation of the photoconductor drum 11Y (i.e., main scanning direction) so that the laser beam L scans the surface of the photoconductor drum 11Y. Thus, an electrostatic latent image corresponding to the yellow component is formed on the surface of the photoconductor drum 11Y after the charger 12 charges the surface of the photoconductor drum 11Y.

Similarly, the laser beam L corresponding to the magenta component is emitted to the surface of the photoconductor drum 11M, which is the second photoconductor drum from the left in FIG. 1, so that an electrostatic latent image corresponding to the magenta component is formed on the surface of the photoconductor drum 11M. The laser beam L corresponding to the cyan component is emitted to the surface of the photoconductor drum 11C, which is the third photoconductor drum from the left in FIG. 1, so that an electrostatic latent image for the cyan component is formed on the surface of the photoconductor drum 11C. The laser beam L corresponding to the black component is emitted to the surface of the photoconductor drum 11BK, which is the fourth photoconductor drum from the left in FIG. 1, so that an electrostatic latent image for the black component is formed on the surface of the photoconductor drum 11BK.

After the electrostatic latent images corresponding to yellow, magenta, cyan, and black are formed on the surfaces of the photoconductor drums 11Y, 11M, 11C, and 11BK, respectively, each surface bearing the electrostatic latent image reaches a position opposite the developing device 13. The developing device 13 supplies toner of each color onto the surface of each of the photoconductor drums 11Y, 11M, 11C, and 11BK and develops the electrostatic latent image on each of the photoconductor drums 11Y, 11M, 11C, and 11BK into a toner image (development process).

Then, the surfaces of the photoconductor drums 11Y, 11M, 11C, and 11BK after the development process each reach a position facing the intermediate transfer belt 17 as an image bearer. At each position facing the intermediate transfer belt 17, the primary transfer roller 14 contacts the inner circumferential face of the intermediate transfer belt 17. The respective color toner images on the photoconductor drums 11Y, 11M, 11C, and 11BK are primary-transferred and sequentially superimposed onto the intermediate transfer belt 17 at the positions of the corresponding primary transfer rollers 14 (primary transfer process).

After the primary transfer process, the surfaces of the photoconductor drums 11Y, 11M, 11C, and 11BK reach positions opposite the cleaning devices 15 (photoconductor cleaning devices), respectively. The untransferred toner remaining on each of the photoconductor drums 11Y, 11M, 11C, and 11BK is removed and collected by the corresponding cleaning device 15 (cleaning process). The untransferred toner removed and collected by the cleaning device 15 is conveyed to and collected in the waste-toner container 80 as waste toner via a conveyance path.

After the cleaning process, the surfaces of the photoconductor drums 11Y, 11M, 11C, and 11BK each pass by a discharger to complete a series of image forming processes performed on the photoconductor drums 11Y, 11M, 11C, and 11BK.

On the other hand, after the toner images on the photoconductor drums 11Y, 11M, 11C, and 11BK are primary-transferred and sequentially superimposed onto the intermediate transfer belt 17 to form the color toner image on the intermediate transfer belt 17 as the image bearer, the intermediate transfer belt 17 bearing the color toner image travels (rotates) counterclockwise in FIG. 1, and the color toner image reaches the position opposite the secondary transfer roller 18. At the position opposite the secondary transfer roller 18, the color toner image borne on the intermediate transfer belt 17 is secondary-transferred onto a sheet P (secondary transfer process).

After the secondary transfer process, the surface of the intermediate transfer belt 17 reaches the position of the cleaning device 30 (intermediate transfer cleaning device). The toner adhering to the intermediate transfer belt 17 (untransferred toner) is removed and collected by the cleaning device 30 to complete a series of image forming processes (transfer processes) performed on the intermediate transfer belt 17. The untransferred toner removed and collected by the cleaning device 30 is conveyed to and collected in the waste-toner container 80 as waste toner via a conveyance path.

As illustrated in FIG. 1, the intermediate transfer belt 17, a plurality of rollers that stretches and supports the intermediate transfer belt 17, and the cleaning device 30 (intermediate transfer cleaning device) are integrated as the intermediate transfer belt unit 16. The intermediate transfer belt unit 16 is detachably attached (installed) into the image forming apparatus 1.

The sheet P is conveyed from the sheet feeder 7 via the registration roller pair 9 to a secondary transfer nip between the intermediate transfer belt 17 and the secondary transfer roller 18. Specifically, a sheet P fed by a sheet feeding roller 8 from the sheet feeder 7 that stores sheets P passes through a conveyance guide and then is guided to the registration roller pair 9. The sheet P that has reached the registration roller pair 9 is conveyed toward the secondary transfer nip, timed to coincide with the arrival of a color toner image on the intermediate transfer belt 17.

Then, the sheet P to which the color image is transferred is guided to the fixing device 20. The fixing device 20 fixes the color image onto the sheet P at a nip between a fixing roller and a pressure roller (fixing process). After the fixing process, the sheet P is ejected as an output image to the outside of the image forming apparatus 1 by a sheet ejection roller. The ejected sheet P is stacked on the sheet ejection tray 5 to complete a series of image forming processes.

An image forming unit in the image forming apparatus will be described below in detail with reference to FIG. 2. Since the image forming units have substantially the same structure, the image forming unit and the developing device illustrated in FIG. 2 omit the alphabets (suffixes) Y, C, M, and BK from the reference numerals.

As illustrated in FIG. 2, the image forming unit includes the photoconductor drum 11, the charger 12, the developing device 13, and the cleaning device 15 (photoconductor cleaning device). The photoconductor drum 11 is a negatively-charged organic photoconductor and is driven to rotate clockwise in FIG. 2 by a main drive motor.

The charger 12 is an elastic charging roller including a core and an elastic layer covering the core. For example, the elastic layer is a foamed urethane layer having moderate resistivity. The foamed urethane layer includes urethane resin, carbon black as conductive particles, a sulfuration agent, and a foaming agent. Examples of the material for the moderate resistance layer of the charger 12 include a rubber material in which a conductive substance such as carbon black or a metal oxide for resistance adjustment is dispersed in urethane, ethylene-propylene-diene polyethylene (EPDM), butadiene acrylonitrile rubber (NBR), silicone rubber, or isoprene rubber, or a foamed material of the rubber material.

The cleaning device 15 includes a cleaning blade that slidingly contacts the photoconductor drum 11 and mechanically removes and collects the untransferred toner from the photoconductor drum 11.

The developing device 13 includes a developing roller 13a, developing conveying screws 13b1 and 13b2, and a doctor blade 13c. The developing roller 13a is disposed close to the photoconductor drum 11 and bears a developer on the surface thereof. The developer (magnetic brush) borne on the developing roller 13a comes into contact with the photoconductor drum 11 to form a developing region (developing nip) between the developing roller 13a and the photoconductor drum 11. The developing device 13 stores the developer including toner and carrier (two-component developer). The developing device 13 develops an electrostatic latent image on the photoconductor drum 11 to form a toner image.

With reference to FIG. 1, the toner container 28 stores toner to be supplied into the developing device 13. Specifically, a magnetic sensor is attached to the developing device 13 to detect toner concentration, i.e., a proportion of the toner in the developer. Based on data of the toner concentration, the toner is appropriately supplied from the toner container 28 to the developing device 13 through a toner supply path.

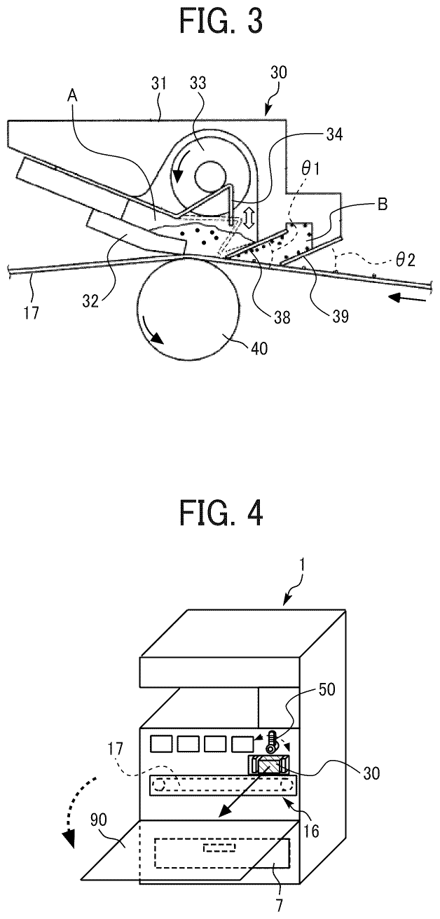

The configuration and operation of the cleaning device 30 (intermediate transfer cleaning device) will be described below with reference to FIGS. 3 to 5.

With reference to FIG. 3, the cleaning device 30 is disposed above the intermediate transfer belt 17 as an image bearer to remove substances such as toner adhering to the intermediate transfer belt 17 (including foreign matter such as paper dust, in addition to untransferred toner).

The cleaning device 30 includes a cleaning blade 32 as a cleaner, a conveying screw 33 as a conveyor, a stirrer 34, a first flexible sheet 38, and a second flexible sheet 39.

The intermediate transfer belt 17 as an image bearer travels (moves) in a predetermined direction (travel direction or moving direction) indicated by an arrow in FIG. 3. The cleaning blade 32 (blade member) as a cleaner contacts the intermediate transfer belt 17 to remove substances such as toner adhering to the surface of the intermediate transfer belt 17 through an opening. The opening is formed on a casing 31 of the cleaning device 30. The opening leads to a first space A, which will be described later.

The cleaning blade 32 is a plate-like component made of a rubber material such as urethane rubber. The cleaning blade 32 is directly or indirectly held (cantilevered) by the casing 31 of the cleaning device 30 such that the leading end of the cleaning blade 32 contacts the intermediate transfer belt 17. The cleaning blade 32 contacts the intermediate transfer belt 17 at a predetermined contact angle and a predetermined contact pressure.

Thus, the toner adhering onto the intermediate transfer belt 17 (including substances, such as paper dust generated from a sheet P, any discharge product generated at the time of discharging in the charging process or transfer process, or any additive added to the toner) is mechanically scraped off and then is collected to the inside of the cleaning device 30 (i.e., the first space A).

The cleaning blade 32 contacts the intermediate transfer belt 17 (at a first position) in the counter direction with respect to the travel direction (moving direction) of the intermediate transfer belt 17 (i.e., against the travel direction).

To maintain the contact force of the cleaning blade 32 to the intermediate transfer belt 17, a counter roller 40 rotatably contacts the inner circumferential face of the intermediate transfer belt 17 such that the cleaning blade 32 is pressed against the counter roller 40 via the intermediate transfer belt 17.

The conveying screw 33 functions as a conveyor that conveys the toner collected in the cleaning device 30 to the outside of the cleaning device 30. Specifically, the conveying screw 33 as a conveyor conveys the substances collected in the first space A between the first flexible sheet 38 and the cleaning blade 32 (i.e., the space in the casing 31 having an opening between the first flexible sheet 38 and the cleaning blade 32).

The conveying screw 33 includes a rotary shaft and a screw spirally wound on the outer circumferential face of the rotary shaft. The conveying screw 33 is driven to rotate by a drive motor to convey the substances (collected matter) such as toner in the width direction substantially orthogonal to the travel direction of the intermediate transfer belt 17 as an image bearer (i.e., in the direction orthogonal to the surface of the paper on which FIG. 3 is drawn). The substances conveyed by the conveying screw 33 are drained outward from the cleaning device 30 and then collected into the waste-toner container 80 (refer to FIG. 1) through a drain path.

The stirrer 34 stirs the substances (collected matter) such as toner collected in the first space A between the first flexible sheet 38 and the cleaning blade 32 (i.e., the space in the casing 31 having the opening between the first flexible sheet 38 and the cleaning blade 32).

The stirrer 34 is a thin plate-like component that is formed with a resin material such as polyethylene terephthalate (PET) and is elastic, and is cantilevered at a position almost the same as the position of the portion through which the cleaning blade 32 is cantilevered by the casing 31. The stirrer 34 has a leading end having a comb shape and is bent in a substantially L-shape. The stirrer 34 contacts the conveying screw 33. Then, while repeatedly coming into contact with the shaft and the screw of the conveying screw 33 in conjunction with rotation of the conveying screw 33, the stirrer 34 swings in the direction indicated by the outlined double-headed arrow in FIG. 3 to stir the substances such as toner collected in the first space A so as to prevent the substances from being aggregated. In other words, the stirrer 34 swings between the position indicated by the solid line and the position indicated by the broken line in FIG. 3.

The first flexible sheet 38 (first inlet seal) is a sheet that contacts the intermediate transfer belt 17 (image bearer) on the upstream side with respect to the cleaning blade 32 (cleaner) in the travel direction of the intermediate transfer belt 17 (i.e., a second position). The first flexible sheet 38 is formed of a flexible material such as polyurethane rubber having a thickness of approximately 0.05 to 0.2 mm. The base of the first flexible sheet 38 is bonded to the casing 31 via a double-sided tape, and thus the first flexible sheet 38 is cantilevered by the casing 31. The leading end of the first flexible sheet 38 slidingly contacts the intermediate transfer belt 17. The length of the first flexible sheet 38 in the width direction (in the direction orthogonal to the surface of the paper on which FIG. 3 is drawn) is substantially the same as the length of the casing 31 in the width direction.

As illustrated in FIG. 3, the first flexible sheet 38 prevents the toner collected inside the cleaning device 30 (inside the first space A) above the intermediate transfer belt 17 from scattering outward from the cleaning device 30.

The second flexible sheet 39 (second inlet seal) is a sheet that contacts the intermediate transfer belt 17 (image bearer) on the upstream side with respect to the first flexible sheet 38 in the travel direction of the intermediate transfer belt 17 (i.e., a third position). The second flexible sheet 39 is formed of a flexible material such as polyurethane rubber having a thickness of approximately 0.05 to 0.2 mm. The base of the second flexible sheet 39 is bonded to the casing 31 via a double-sided tape, and thus the second flexible sheet 39 is cantilevered by the casing 31. The leading end of the second flexible sheet 39 slidingly contacts the intermediate transfer belt 17. The length of the second flexible sheet 39 in the width direction (in the direction orthogonal to the surface of the paper on which FIG. 3 is drawn) is substantially the same as the length of the first flexible sheet 38 in the width direction.

The leading end (contact part with the intermediate transfer belt 17) of the second flexible sheet 39 and the leading end (contact part with the intermediate transfer belt 17) of the first flexible sheet 38 are spaced apart from each other at an interval of approximately 5 to 10 mm in the travel direction.

A second space B (i.e., the space in the casing 31 having the opening between the second flexible sheet 39 and the first flexible sheet 38) is formed between (defined by) the second flexible sheet 39 and the first flexible sheet 38 and is isolated from the first space A. In other words, the inside of the casing 31 is partitioned into the first space A and the second space B with a wall (i.e., the first flexible sheet 38) as different spaces from each other. The portion of the casing 31 in which the second space B is formed projects upstream in the travel direction of the intermediate transfer belt 17.

As described above, the cleaning device 30 includes the second flexible sheet 39 disposed upstream of the first flexible sheet 38. Accordingly, even when the contact part of the first flexible sheet 38 with the intermediate transfer belt 17 is undulated (becomes wavy), the substances such as toner collected inside the cleaning device 30 (inside the first space A) are less likely to leak outward from the cleaning device 30 (from the casing 31).

Specifically, as described above, since the first flexible sheet 38 is bonded to the casing 31 via a double-sided tape, the leading end of the first flexible sheet 38 is likely to be undulated (become wavy) even at an early stage in a manufacturing process or over time. If the undulated leading end of the first flexible sheet 38 contacts the intermediate transfer belt 17, the contact pressure at the contact part is not uniform, and thus the substances may leak through a part having a low contact pressure.

In a cleaning device 130 without the second flexible sheet 39, as illustrated in FIG. 6, according to a comparative example, the substances leaking through the contact part between the first flexible sheet 38 and the intermediate transfer belt 17 may adhere to the casing 131 or scatter outward from the casing 131. As a result, the scattered substances may contaminate other components.

In contrast, in the cleaning device 30 according to the present embodiment, even if the substances are not collected in the first space A and leak through the contact part between the first flexible sheet 38 and the intermediate transfer belt 17, the leaking substances are collected (stored) in the second space B. Thus, the substances can be prevented from adhering to the casing 31 or from scattering outward from the casing 31 and contaminating other components.

In particular, the cleaning device 30 according to the present embodiment includes the stirrer 34 that stirs the substances in the first space A. The substances stirred by the stirrer 34 may push the first flexible sheet 38, and thus the undulation (waving) of the first flexible sheet 38 described above may increase. In such a case, the substances are more likely to leak through the contact part between the first flexible sheet 38 and the intermediate transfer belt 17. For this reason, the second flexible sheet 39 is more useful.

The substances (collected matter) such as toner are temporarily collected (stored) in the second space B. The substances temporarily adhering to the inner wall of the second space B fall due to, for example, vibrations, and adhere to the surface of the intermediate transfer belt 17 again. The substances adhering to the intermediate transfer belt 17 again are scraped off from the intermediate transfer belt 17 by the cleaning blade 32 again and then are collected in the first space A. Thus, a conveyor that conveys the substances in the second space B outward from the cleaning device 30 or a large-volume second space B is unnecessary.

The first flexible sheet 38 and the second flexible sheet 39 both are in contact with the intermediate transfer belt 17 (image bearer) at an inclination along the travel direction (moving direction), while following the movement of the intermediate transfer belt 17 in the travel direction. In other words, the first flexible sheet 38 and the second flexible sheet 39 are each cantilevered by the casing 31 such that the first flexible sheet 38 and the second flexible sheet 39 contact the intermediate transfer belt 17 not in the counter direction but in the trailing direction.

Due to such a configuration, the substances adhering to the surface of the intermediate transfer belt 17 are not scraped off by the first flexible sheet 38 and the second flexible sheet 39 and move to the position of the cleaning blade 32 while adhering to the intermediate transfer belt 17. In addition, the substances (collected matter) collected in the first space A and the second space B are less likely to scatter upstream with respect to the first flexible sheet 38 and the second flexible sheet 39.

The contact pressure of the second flexible sheet 39 to the intermediate transfer belt 17 (image bearer) is equal to or less than the contact pressure of the first flexible sheet 38 to the intermediate transfer belt 17. Thus, the substances adhering to the intermediate transfer belt 17 are not scraped off by the second flexible sheet 39 before reaching the position of the cleaning blade 32. A difference in material, thickness, or projecting length between the first flexible sheet 38 and the second flexible sheet 39 can cause such a difference in the contact pressure between the first flexible sheet 38 and the second flexible sheet 39.

A contact angle θ2 of the second flexible sheet 39 to the intermediate transfer belt 17 (image bearer) is equal to or less than a contact angle θ1 of the first flexible sheet 38 to the intermediate transfer belt 17 (θ1≥θ2). Thus, the substances adhering to the intermediate transfer belt 17 are not scraped off by the second flexible sheet 39 before reaching the position of the cleaning blade 32. As illustrated in FIG. 3, the “contact angles θ1 and θ2” are the respective angles of the first flexible sheet 38 and the second flexible sheet 39 to the intermediate transfer belt 17 that travels in the direction indicated by the arrow in FIG. 3. A difference in shape (inclined angle) to the casing 31 to which the bases of the first flexible sheet 38 and the second flexible sheet 39 are bonded can cause such a difference in the contact angle between the first flexible sheet 38 and the second flexible sheet 39.

The cleaning device 30 is detachably attached to the intermediate transfer belt unit 16 (image forming apparatus 1) including the intermediate transfer belt 17. Specifically, as illustrated in FIG. 4, after a body cover 90 of the image forming apparatus 1 is swung (opened) in the direction indicated by the broken arrow in FIG. 4 to expose the interior of the image forming apparatus 1, a lock lever 50 is manually released and then the cleaning device 30 is pulled out from the image forming apparatus 1 in the direction indicated by the solid arrow in FIG. 4, or the cleaning device 30 is attached to the image forming apparatus 1 in the direction opposite to the direction indicated by the solid arrow and then is locked by the lock lever 50. Such attachment and detachment operations of the cleaning device 30 are performed when a user replaces the cleaning device 30 that has reached the end of lifespan with a new cleaning device 30 or when a service person maintains the cleaning device 30.

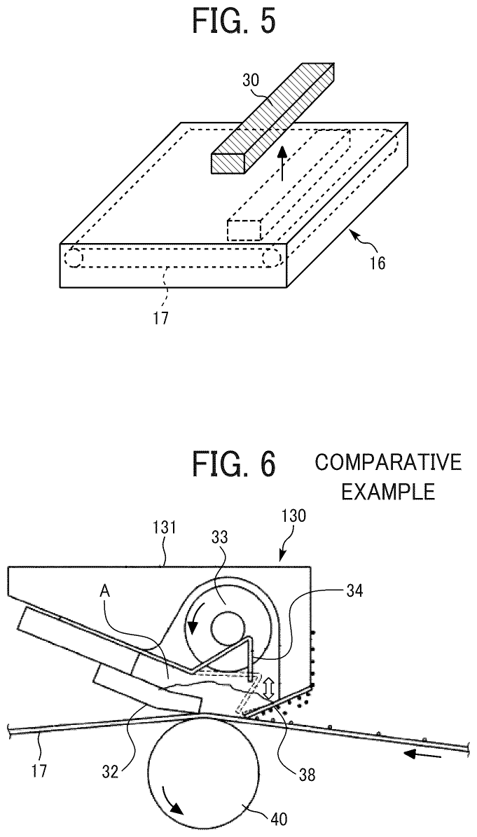

In FIG. 4, with the intermediate transfer belt unit 16 attached to the image forming apparatus 1, the cleaning device 30 can be attached to or detached from the intermediate transfer belt unit 16. Instead, with reference to FIG. 5, with the intermediate transfer belt unit 16 pulled out (or completely detached) from the image forming apparatus 1, the cleaning device 30 can be attached to or detached from the intermediate transfer belt unit 16.

### Modification

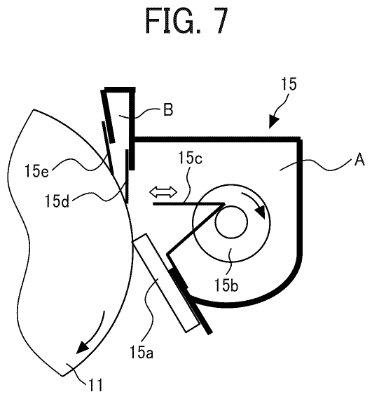

As illustrated in FIG. 7, according to a modification, a cleaning device 15 for a photoconductor drum 11 (photoconductor cleaning device) includes a second flexible sheet 15e. The cleaning device 15 for the photoconductor drum 11 includes a cleaning blade 15a as a cleaner, a conveying screw 15b as a conveyor, a stirrer 15c, a first flexible sheet 15d, and the second flexible sheet 15e.

The cleaning blade 15a functions as a cleaner that contacts the photoconductor drum 11 as an image bearer, which rotates (travels) in a predetermined rotation direction (travel direction), to remove substances such as untransferred toner adhering to the surface of the photoconductor drum 11.

The first flexible sheet 15d contacts the photoconductor drum 11 on the upstream side with respect to the cleaning blade 15a in the rotation direction (on the upstream side in the travel direction) of the photoconductor drum 11.

The second flexible sheet 15e contacts the photoconductor drum 11 on the upstream side with respect to the first flexible sheet 15d in the rotation direction (on the upstream side in the travel direction) of the photoconductor drum 11.

A first space A is formed between (defined by) the first flexible sheet 15d and the cleaning blade 15a to collect the substances removed from the surface of the photoconductor drum 11 by the cleaning blade 15a. Further, a second space B isolated from the first space A is formed between (defined by) the second flexible sheet 15e and the first flexible sheet 15d. The conveying screw 15b functions as a conveyor that conveys the substances collected in the first space A. The stirrer 15c stirs the substances collected in the first space A.

In the cleaning device 15 according to the modification, the cleaning blade 15a, the conveying screw 15b, the stirrer 15c, the first flexible sheet 15d, and the second flexible sheet 15e function almost similarly to the cleaning blade 32, the conveying screw 33, the stirrer 34, the first flexible sheet 38, and the second flexible sheet 39 of the cleaning device 30 illustrated in FIG. 3, except for the difference between the image bearers (i.e., the photoconductor 11 and the intermediate transfer belt 17). Thus, the substances collected in the cleaning device 15 are less likely to leak outward from the cleaning device 15.

As described above, the cleaning device 30 includes: the cleaning blade 32 (cleaner) that contacts the intermediate transfer belt 17 (image bearer), which travels in the travel direction, to remove substances adhering to the surface of the intermediate transfer belt 17; the first flexible sheet 38 that contacts the intermediate transfer belt 17 on the upstream side with respect to the cleaning blade 32 in the travel direction of the intermediate transfer belt 17; and the second flexible sheet 39 that contacts the intermediate transfer belt 17 on the upstream side with respect to the first flexible sheet 38 in the travel direction of the intermediate transfer belt 17. Thus, the substances collected in the cleaning device 30 are less likely to leak outward from the cleaning device 30.

As described above, the present disclosure has been applied to the cleaning device 30 for the intermediate transfer belt 17 and the cleaning device 15 for the photoconductor drum 11, but the present disclosure can be naturally applied to a cleaning device for an intermediate transfer drum as an image bearer or a cleaning device for a photoconductor belt as an image bearer. Even in such cases, effects similar to the effects described above can be obtained.

The present disclosure is not limited to the above-described embodiment, modifications, and variations, and the configuration of the present embodiment can be appropriately modified other than suggested in the above embodiment, modifications, and variations within a scope of the technological concept of the present disclosure. The number, position, and shape of the components described above are not limited to those embodiments described above. Desirable number, position, and shape can be determined to perform the present disclosure.

The present disclosure may be applicable to, for example, a combination of the following Aspects 1 to 7.

### Aspect 1

A cleaning device includes a cleaner, a first flexible sheet, and a second flexible sheet. The cleaner contacts an image bearer that travels in a travel direction to remove substances adhering to a surface of the image bearer. The first flexible sheet contacts the image bearer on an upstream side with respect to the cleaner in the travel direction of the image bearer. The second flexible sheet contacts the image bearer on an upstream side with respect to the first flexible sheet in the travel direction of the image bearer.

In other words, a cleaning device includes a cleaner, a first flexible sheet, and a second flexible sheet. The cleaner contacts, at a first position, a surface of an image bearer moving in a moving direction to remove substances adhering to the surface of the image bearer. The first flexible sheet contacts the image bearer at a second position upstream of the first position in the moving direction. The second flexible sheet contacts the image bearer at a third position upstream of the second position in the moving direction.

### Aspect 2

The cleaning device according to Aspect 1, has a first space and a second space. The first space is formed between the first flexible sheet and the cleaner to collect the substances removed from the surface of the image bearer by the cleaner. The second space is formed between the second flexible sheet and the first flexible sheet and isolated from the first space. The cleaning device further includes a stirrer that stirs the substances collected in the first space and a conveyor that conveys the substances collected in the first space.

In other words, the cleaning device according to Aspect 1, further includes: a stirrer, a conveyor, a first space, and a second space. The stirrer stirs the substances removed by the cleaner. The conveyor conveys the substances. The first space is disposed between the cleaner and the first flexible sheet in the moving direction to collect the substances in the first space. The second space is: disposed between the first flexible sheet and the second flexible sheet in the moving direction; and isolated from the first space by the first flexible sheet, to collect the substances not collected in the first space. The stirrer stirs the substances collected in the first space, and the conveyor conveys the substances collected in the first space.

### Aspect 3

In the cleaning device according to Aspect 1 or 2, the first flexible sheet and the second flexible sheet both contact the image bearer along the travel direction.

In other words, each of the first flexible sheet and the second flexible sheet is in contact with the image bearer at an inclination along the moving direction.

### Aspect 4

In the cleaning device according to any one of Aspects 1 to 3, a contact pressure of the second flexible sheet to the image bearer is equal to or less than a contact pressure of the first flexible sheet to the image bearer.

In other words, the first flexible sheet contacts the image bearer at a first contact pressure, and the second flexible sheet contacts the image bearer at a second contact pressure equal to or less than the first contact pressure.

### Aspect 5

In the cleaning device according to any one of Aspects 1 to 4, a contact angle of the second flexible sheet to the image bearer is equal to or less than a contact angle of the first flexible sheet to the image bearer.

In other words, the first flexible sheet contacts the image bearer at a first contact angle, and the second flexible sheet contacts the image bearer at a second contact angle equal to or less than the first contact angle.

### Aspect 6

In an intermediate transfer belt unit to be attached to an image forming apparatus, the intermediate transfer belt unit includes: an intermediate transfer belt as the image bearer; and the cleaning device according to any one of Aspects 1 to 5 detachably attached to a body of an image forming apparatus.

In other words, an intermediate transfer belt unit includes the image bearer including an intermediate transfer belt movable in the moving direction. The cleaning device according to any one of Aspects 1 to 5 is detachably attached to the intermediate transfer belt in an image forming apparatus.

### Aspect 7

An image forming apparatus includes the cleaning device according to any one of Aspects 1 to 5 or the intermediate transfer belt unit according to Aspect 6.

In other words, an image forming apparatus includes: an image bearer to move in a moving direction to form an image on a surface of the image bearer; and the cleaning device according to any one of Aspects 1 to 5, to clean the surface of the image bearer.

Alternatively, an image forming apparatus includes: the intermediate transfer belt unit according to claim 6; and an image forming unit to form an image on the intermediate transfer belt.

As described above, according to one aspect of the present disclosure, a cleaning device, an intermediate transfer belt unit, and an image forming apparatus can be provided that prevent substances collected in the cleaning device from leaking outward from the cleaning device.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A cleaning device comprising:
a cleaner contacting, at a first position, a surface of an image bearer moving in a moving direction,
to remove substances adhering to the surface of the image bearer;
a first flexible sheet contacting the image bearer at a second position upstream of the first position in the moving direction; and
a second flexible sheet contacting the image bearer at a third position upstream of the second position in the moving direction.

2. The cleaning device according to claim 1, further comprising:
a stirrer to stir the substances removed by the cleaner;
a conveyor to convey the substances;
a first space between the cleaner and the first flexible sheet in the moving direction to collect the substances in the first space; and
a second space:
between the first flexible sheet and the second flexible sheet in the moving direction; and
isolated from the first space by the first flexible sheet,
to collect the substances not collected in the first space,
wherein the stirrer stirs the substances collected in the first space, and
the conveyor conveys the substances collected in the first space.

3. The cleaning device according to claim 1,
wherein each of the first flexible sheet and the second flexible sheet is in contact with the image bearer at an inclination along the moving direction.

4. The cleaning device according to claim 1,
wherein the first flexible sheet contacts the image bearer at a first contact pressure, and
the second flexible sheet contacts the image bearer at a second contact pressure equal to or less than the first contact pressure.

5. The cleaning device according to claim 1,
wherein the first flexible sheet contacts the image bearer at a first contact angle, and
the second flexible sheet contacts the image bearer at a second contact angle equal to or less than the first contact angle.

6. An intermediate transfer belt unit comprising:
the image bearer including an intermediate transfer belt movable in the moving direction,
wherein the cleaning device according to claim 1 is detachably attached to the intermediate transfer belt in an image forming apparatus.

7. An image forming apparatus comprising:
an image bearer to move in a moving direction to form an image on a surface of the image bearer; and
the cleaning device according to claim 1, to clean the surface of the image bearer.

8. An image forming apparatus comprising:
the intermediate transfer belt unit according to claim 6; and
an image forming unit to form an image on the intermediate transfer belt.
